(19) United States
(12) Patent Application Publication
(10) Pub. No.: US 2003/0003214 A1
(43) Pub. Date: Jan. 2, 2003

(54) Complete dough shelf stable at room temperature

(76) Inventors: Harry K. Kraklow, Eau Claire, WI (US); Cynthia R. Kandler, Chippewa Falls, WI (US)

Correspondence Address: Tipton L. Randall, 19371 55th Avenue, Chippewa Falls, WI, 54729, US

(21) Appl. No.: 10/189,895

(22) Filed: Jul. 3, 2002

Related U.S. Application Data
(63) Continuation-in-part of application No. 09/946,494, filed on Sep. 6, 2001.
(60) Provisional application No. 60/290,396, filed on May 14, 2001.

(51) Int. Cl. A21D 2/00

(52) U.S. Cl. 426/551

(57) ABSTRACT

The invention is directed to a complete sweet goods dough composition which is shelf stable at both room temperature and in an ambient atmosphere. The dough includes preselected amounts of flour, shortening, emulsifier, eggs, encapsulated leavening, salt, flavoring, a mold inhibitor and a source of sugar in an amount of about 20 to about 40 weight percent, including a fluid corn syrup/sugar blend, the sugar effective to provide an A_{w} of less than about 0.75 for the dough product. The dough product has a pH with a range from about 6.5 to about 8.5, and is stable at ambient temperature and atmosphere for extended periods without degradation. The dough product produces a baked food product that is acceptable to consumers.

### CROSS-REFERENCE TO RELATED APPLICATIONS, IF ANY

This application claims the benefit under 35 U.S.C. §119 (e) of provisional application Serial No. 60/290,396, filed May 14, 2001, and co-pending utility application Ser. No. 09/946,494 filed Sep. 6, 2001.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates to a sweet goods dough composition and, more particularly, to a shelf stable sweet goods dough composition which remains free from microbiological growth at both room temperature and in an ambient atmosphere for extended periods.

2. Background Information.

Grain based baked products, such as breads, cakes, cookies, etc., have been a food staple for man since biblical times. Some type of finely ground grain is combined with additional ingredients, such as sweeteners, eggs, fats, milk, etc., and the resulting dough is baked to produce a food product with moderate storage stability. Generally, such a dough mixture is freshly prepared from the selected ingredients shortly before baking. The fresh dough has limited stability and is not suitable for storage for even a few days at room temperature. Separation of components and microbial growth occur quickly for such fresh dough products.

A recent development in the food industry is the preparation of dough for sweet food products, such as bread or cookies, then freezing or refrigerating the dough for storage and later use. Such frozen or refrigerated dough products are widely available to the consumer, but these products often command premium prices. The high cost for these frozen or refrigerated dough products is mainly linked to the cost of freezing and refrigeration during storage and distribution of the frozen dough. These frozen doughs are specially formulated to survive freezing and thawing while still producing a baked food product acceptable to consumers. Some examples of dough or batter compositions for which patents have been granted include the following.

In U.S. Pat. No. 4,910,029, Thulin et al. disclose a shelf-stable cookie having a plurality of textures and visually apparent flavor chips characteristic of freshly baked homemade cookies. The cookie is baked from dough pieces comprising chewy cookie dough or filling enrobed in crispier cookie dough.

Lou et al., in U.S. Pat. No. 4,911,939, describe a cookie dough that is formed into individual cookie pieces and prebaked for a short period of time in order to shape the cookie and provide a gluten-containing skin on the cookie's surface. The prebaked cookie is then packaged for microwave baking at some future time.

In U.S. Pat. No. 5,171,599, Weber discloses a low water activity refrigerated cookie dough composition which includes edible bits containing coloring agents. The dough product is substantially free of color bleed after 90 days of refrigeration. The dough composition has a water activity no greater than about 0.75.

In U.S. Pat. No. 5,223,292, Thulin et al. disclose a cookie having an extended shelf-stable soft texture. The cookies are prepared by coextruding an inner adherent cookie dough bakeable to a soft or chewy texture and an outer non-adherent cookie dough also bakeable to a soft or chewy texture.

Kent et al., in U.S. Pat. No. 5,409,720, describe a room temperature shelf stable dough mix that includes a moist ingredient portion and a dry ingredient portion capable of being combined to produce a complete dough requiring no additional ingredients including water or any other moisture. The moist ingredient portion has a water activity level of no greater than 0.85 to provide the desired shelf stability. Both the moist and dry ingredient portions are preferably packaged in substantially air and water impermeable containers of single batch volumes, such that the contents of the packages may be simply mixed together to produce the complete dough without measuring.

In U.S. Pat. No. 6,217,929, Hahn discloses spoonable, low water activity batters. The flour-based batter composition is spoonable at refrigeration temperature and has a refrigerated shelf life of at least about 75 days. The batter has an intermediate water activity of about 0.81 to 0.92. The batters can be baked into products such as muffins, pancakes, waffles, brownies, and other foods that have a high, fluffy texture and a baked height to raw height ratio of greater than about one.

Thus, there is an unmet need for dough products that can be stored at room temperature and in an ambient atmosphere for extended periods without degradation, and then produce a baked food product that is acceptable to consumers.

### SUMMARY OF THE INVENTION

The invention is directed to a complete sweet goods dough composition that is shelf stable at both room temperature and in an ambient atmosphere. The dough includes a structure-providing amount of flour and sugar, the sugar in an amount of about 20 to 40 weight percent, including a fluid corn syrup/sugar blend. There is an amount of shortening, or equivalent product, effective to enhance the organoleptic properties of the dough, and an amount of eggs to provide body to a finished product. An effective amount of emulsifier preventing component separation is present. The dough includes an effective amount of an encapsulated leavening system to provide the finished product a desired density, and an effective amount of a mold inhibiting agent to prevent mold growth therein. The dough has a pH with a range from about 6.5 to about 8.5, an A_{w} of less than about 0.75, and is shelf stable both at room temperature and in an ambient atmosphere for extended storage.

Tests indicate that an A_{w} no greater than about 0.75 in the complete sweet goods dough suppresses microbial growth and, therefore, prevents spoilage of the dough composition even at room temperature and in an ambient atmosphere. The mold inhibiting agent also assists in preventing the growth of mold during storage of the complete sweet goods dough. The complete sweet goods dough composition of the present invention, with the required A_{w} no greater than about 0.75, is shelf stable at both room temperature and in an ambient atmosphere even though the composition includes whole eggs. Tests indicate that the dough composition, according to the present invention, has a shelf life at both room temperature and in an ambient atmosphere of at least 90 days, and up to about 210 days or more.

### DESCRIPTION OF THE EMBODIMENTS

As noted above, the various prepared bread and cookie doughs presently available to consumers are either frozen or require refrigeration during manufacture and storage to maintain quality. Applicants have invented a sweet goods dough composition which does not require refrigeration or freezing during manufacture or storage, and exhibits stability to both separation of components and microbial growth for extended periods. Also disclosed is a method of preparation of the complete sweet goods dough compositions of the present invention that is shelf stable at both room temperature and in an ambient atmosphere.

The complete dough compositions of the present invention that is shelf stable at both room temperature and in an ambient atmosphere has a water activity (Aw) no. greater than about 0.75. Tests indicate that the dough compositions, according to the present invention, have a shelf life at both room temperature and in an ambient atmosphere of at least 90 days, and up to about 210 days or more, even with whole eggs included in the dough product. As used in this disclosure, room temperature means a temperature above refrigeration temperature (40° F.) and extending up to about 110° F. As used in this disclosure, “shelf stable” means freedom from substantial bacterial, mold, and fungus growth at both room temperature and in an ambient atmosphere for a period of at least 90 days. As used in this disclosure, an ambient atmosphere means an atmosphere comprising about 78% nitrogen, 21% oxygen and 1% other gases, i.e. the normal atmosphere of the earth. As used in this disclosure, water activity or A_{w} may be defined as the ratio of vapor pressure of a solution or mixture to that of pure water at a specific temperature. Thus, A_{w} equals the equilibrium relative humidity. The water activity is a measure of the free or available water in the dough mixture. As is known in the industry, water activity may be measured by measuring the equilibrium vapor pressure of a mixture at a particular temperature and expressing that value as a ratio of the mixture equilibrium vapor pressure to the equilibrium water vapor pressure of water at that temperature.

It is believed that the A_{w} value of the present dough composition is lowered to the 0.75 value by hydrogen bonding between the sugars or other ingredient molecules of the dough and water molecules. The hydrogen bonding ties up the water molecules, preventing free movement of water molecules in the dough composition. Although the mechanism of “binding” the water molecules in the dough system is not precisely understood, this “binding” prevents the growth of microbial organisms in the dough product at both room temperature and in an ambient atmosphere for at least about 90 days, and up to about 210 days or more. A mold inhibiting agent also prevents the growth of mold during storage of the compete sweet goods dough. The sweet good dough mixture of the present invention is suitable for producing baked goods including, but not limited to, cookies, brownies, cakes, sweet breads, pie dough and muffins.

The sweet goods dough of the present invention contains a flour component that contributes to the structure of the sweet goods dough, including the texture, taste and appearance of the final baked product. Useful flours include hard wheat flour, soft wheat flour, barley flour, rice flour, oat flour, high amylose flour and low amylose flour. The sweet goods dough preferably contains about 20-40 weight percent flour, and most preferably about 30-37 weight percent flour.

For purposes of this disclosure and the accompanying claims, “sugar” may include appropriate monosaccharides and disaccharides in either refined or unrefined forms and includes both granulated and powdered sucrose, raw sugar, turbinado sugar, brown sugar, and invert sugar. The sugar incorporated in the dough composition according to the present invention may also include sweeteners such as fructose, dextrose, glycerol, glycerin, maltose, arabinose, sorbitol, maple syrup, corn syrup, molasses, honey, fondant, aspartame, saccharin, acesulfame K, polydextrose, sucralose, alitame and isomalt. The sweet goods dough preferably contains about 20-40 weight percent sugar, and most preferably, about 25-36 weight percent sugar.

“Shortening” may include any suitable edible fat or fat substitute in either solid or liquid form at room temperature, including vegetable oil, sunflower oil, safflower oil, cottonseed oil, canola oil, soybean oil, olive oil, coconut oil, and palm oil. As used herein, “shortening” may also include fat substitutes including cellulose, gums dextrins, maltodextrins, modified food starch, polydextrose, microparticulated protein, protein blends, emulsifiers, lipid analogs, esterified propoxylated glycerol, and sucrose polyesters. Shortening has beneficial effects on the volume, grain and texture of the baked sweet goods product, as well as the texture, mouthfeel and other organoleptic properties of the baked good. The sweet goods dough preferably contains about 10-20 weight percent shortening, and most preferably, about 10-15 weight percent shortening.

“Emulsifier” may include any suitable edible surfactant that increases dough stability and prevents component separation during storage and baking. Separation of components results in a dough that does not bake properly and produces an unacceptable finished product. Emulsifiers can including sodium stearoyl lactylate, sorbitan monostearate, lactylate hydrate, polysorbate 60, polysorbate 80, lecithin, mono- and diglycerides of fatty acids, propylene glycol mono- and diglycerides of fatty acids, glycerol-lacto esters of fatty acids, ethoxylated mono- and diglycerides, and the like. The sweet goods dough of the present invention most preferably contains about 2-4 weight percent of emulsifier.

The composition of the sweet goods dough of the present invention includes sucrose, a fluid corn syrup/sugar blend, shortening, flour, eggs, emulsifier, flavoring, encapsulated sodium bicarbonate, salt, and mold inhibitor. Additional ingredients can include cocoa, chocolate chips/chunks, fruit pieces such as raisins, and candy pieces such as gummy chunks.

In a preferred embodiment of the sweet goods dough composition, the sucrose includes a mixture of white sugar and brown sugar in a 1.72:1.00 ratio by weight, while the ratio of fluid corn syrup/sugar blend to sucrose is about 1.00:2.50 by weight. In a most preferred embodiment of the sweet goods dough composition, the fluid corn syrup/sugar blend is a material denoted as CFP Blend 2001, which includes 63% of 36DE corn syrup, 8% High Fructose 42, 28% liquid sucrose, and 1% imitation vanillin. Each of the blend components is known in the industry and commercially available. The 36DE corn syrup typically contains 80% solids and 20% water, the High Fructose 42 typically contains 70% solids and 30% water, and the liquid sucrose typically contains 68% solids and 32% water.

In a preferred embodiment of the sweet goods dough composition, the shortening includes a mixture of solid and liquid shortening in a ratio of about 3.0:1.0 by weight. Most preferably, the solid shortening is a partially hydrogenated blend of vegetable soybean oil and cottonseed oil material. A suitable solid shortening product is available from Archer Daniels Midland Co., Decater, Ill., and denoted as product code number 101-050. The liquid shortening is most preferably a soybean oil, well known in the food industry and available from numerous suppliers. In a preferred embodiment of the sweet goods dough composition, the flour includes a mixture of bleached, enriched wheat flour and barley flour in a ratio of about 10.0:1.00 by weight.

The eggs utilized for the dough composition are commercially available whole eggs which are preserved. In a preferred embodiment of the sweet goods dough composition, the eggs are a preserved whole egg product known as Ultraegg^{(R)}, widely used in the food industry and available from Cutler Egg Products, Inc., Abbeville, Ala. The preserved egg product, which is a fluid, containing equal amounts of whole eggs and sugar (sucrose) as a preservative, is guaranteed to be free of Salmonella, Listeria, Staph and E. coli. The Ultraegg^{(R)} preserved egg product typically contains 72% solids and 28% moisture. The preserved egg product is stable to microbial and mycotic degradation at room temperature for at least about six months. The preserved egg product is preferably present in the sweet goods dough at about 8-15 weight percent, and most preferably about 10-14 weight percent. The eggs provide body to the sweet goods dough both in the unbaked and baked condition.

The emulsifier of the sweet goods dough of the present invention includes a mixture of lactylate hydrate and lecithin in a ratio of about 3.0:1.0 by weight. Lactylate hydrate is composed of sodium stearol lactylate, ethoxylated monoglycerides, polysorbate 60 and propionic acid. Lactylate hydrate is available from Custom Ingredients, Inc., New Braunfels, Tex. Lecithin is well known in the food industry and available from numerous suppliers, including Archer Daniels Midland Co., Decater Ill.

In a preferred embodiment of the sweet goods dough composition, the flavoring includes a mixture of clear artificial vanilla flavoring and a butter/vanilla/lemon flavoring in a ratio of about 2.0:1.0 by weight, to improve flavor of the sweet goods dough. The flavoring is present in the sweet goods dough at about 1.0-1.7 weight percent.

An encapsulated sodium bicarbonate is employed in the preferred embodiment of the sweet goods dough composition. Sodium bicarbonate, encapsulated with a solid shortening, is well known in the food industry and commercially available from numerous sources. Encapsulating sodium bicarbonate in a solid shortening prevents reaction of the sodium bicarbonate with water or other dough components during storage at both room temperature and in an ambient atmosphere. Only upon baking the sweet goods dough does the encapsulated sodium bicarbonate become available to produce leavening of the finished product. The encapsulated sodium bicarbonate is present in the sweet goods dough at about 0.5-1.5 weight percent and, most preferably, at about 0.9-1.2 weight percent.

The preferred embodiment of the sweet goods dough composition includes about 0.5% salt by weight, to improve taste of the sweet goods dough, and a mold inhibitor effective in preventing molding of the sweet goods dough during prolonged storage at both room temperature and in an ambient atmosphere. Preferably, the mold inhibitor is present in the sweet goods dough at about 0.07-0.12 weight percent and, more preferably, at about 0.08-0.10 weight percent. Most preferably, the mold inhibitor is potassium sorbate present at about 0.1% by weight in the dough composition. Potassium sorbate is widely known in the food industry and readily available from suppliers. Other antimycotic agents which may inhibit the growth of undesirable yeasts and/or molds in the dough composition include salts of acetic acid, salts of propionic acid, salts of lactic acid, salts of citric acid, or calcium phosphate. These agents are generally present in the dough composition at about 0.1 to 0.2% by weight. Too little mold inhibitor will not provide sufficient antimycotic effect, while too much can impart an off taste to the dough product.

The above compositions of the sweet goods dough invention provide a basic sweet goods dough product that is stable at both room temperature and in an ambient atmosphere for at least about 90 days, and up to about 210 days or more. This basic dough can be supplemented with additional edible particulate substances, including chocolate chips, white and dark chocolate chunks, various candy bits, or oatmeal and raisins, to produce a similar complete sweet goods dough, shelf stable at both room temperature and in an ambient atmosphere, containing any of the additional edible particulates.

Also included in the present invention is a process for preparing the complete room temperature, ambient atmosphere, shelf stable sweet goods dough compositions. A commercial mixing machine is employed to mix the ingredients in a single container. Suitable mixing machines are available from numerous manufacturers and are well known in the industry. Since the process for preparing the sweet goods dough composition of the present invention involves sequential steps, the sweet goods dough is preferably prepared by a batch process. The process includes the steps of first mixing together, also termed “creaming,” the selected amounts of sugar, fluid corn syrup/sugar blend, shortening, eggs, emulsifier, flavoring, salt, and mold inhibitor in the mixer to form a first creamed slurry. The duration of mixing is well known to those skilled in the art and varies depending upon the particular dough mixture. The “creaming” step duration varies with the mixing machine used and continues until the first creamed slurry exhibits a color similar to a yellow cake batter in the case of a cookie dough. Next, the selected amount of flour, plus sodium carbonate in the case of oatmeal/raisin cookies, is added to and mixed with the first creamed slurry to produce a first dough mixture. Lastly, a selected amount of encapsulated sodium bicarbonate is added and mixed with the first dough mixture to produce a final dough product with a water activity less than about 0.75 and a pH with a range from about 6.5 to about 8.5.

Additional edible particulates, including chocolate chips, white and dark chocolate chunks, various candy bits, or oatmeal and raisins, are mixed into the final dough product to produce a sweet goods dough having the edible particulates distributed therein. The final dough product is transferred to a suitable container that can be sealed for storage of the dough product at both room temperature and in an ambient atmosphere for at least about 90 days, and up to 210 days or more, without separation of components and without microbial growth.

The process for preparing the sweet goods dough compositions of the present invention is carried out in an ambient atmosphere at temperatures in the range from of about 60° to about 1000 F, in accordance with good manufacturing practices (GMP). The machinery and utensils used in preparing the sweet goods dough compositions require no special sterilization or other anti-mycotic treatment beyond being clean and dry, as is used with any food goods preparation equipment according to good manufacturing practices (GMP).

The sweet goods dough composition of the present invention, prepared by a batch process in a commercial mixing machine, results in a stiff, viscous dough mixture. Commercial machines fitted with augers or pistons for transferring and packaging dough are commonly employed in the industry. One machine suitable for transferring and packaging of the stiff, viscous sweet goods dough mixture is a VEMAG filler, the Robot 500, having a dough reservoir and a double screw auger, available from Robert Reiser and Co., Inc., Canton, Mass. The standard auger used with the VEMAG filler, designed for handling meat products, resulted in damage to the edible particulates passing through the machine, with the broken edible particulates discoloring the sweet goods dough, due to coloration bleeding from the damaged edible particulates into the dough. To enable the machine to properly move the stiff, viscous sweet goods dough mixture through it without damage to the edible particulates, the VEMAG filler standard auger was replaced with a 72 String Cheese 367 double screw auger, part number 912380040. The VEMAG machine, fitted with this double screw auger, provides facile transferring of the stiff, viscous, sweet goods dough mixture, without damage to the edible particulates, and mechanized filling of dough containers suitable for sale and use by institutions and consumers. Alternatively, the sweet good dough cylinders extruded by the dough handling machine may be cut into uniform pieces (cookie size or muffin size), which are placed on paper sheets and the dough-containing paper sheets stacked in a cardboard carton for distribution.

Other machines suitable for transferring and packaging the stiff, viscous, sweet good dough mixture are Marlen dough pumps, available from Marlen Research Corporation, Overland Park, Kans. Marlen dough pumps, such as Models 629 or 670, operate with twin pistons that provide a precise metered flow of sweet goods dough without pulsation. The pistons readily transfer the stiff viscous, sweet good dough mixture without damage to the edible particulates distributed therein.

The containers for the sweet goods dough mixture need not be oxygen impervious or air tight. Simple plastic containers with friction fit lids are sufficient. Should the container integrity be compromised by, for example, a puncture, the sweet goods dough mixture maintains its shelf stability for at least 90 days. Should the dough container cover be inadvertently left open, the dough mixture may dry to a limited extent, but the dough mixture will maintain its shelf stability for at least 90 days.

The preferred complete dough compositions disclosed in the following examples were formulated to better illustrate the scope of the present invention. In examples 1-4 below, the fluid corn syrup/sugar blend to sucrose ratio was 1.0:2.5 by weight, the solid to liquid shortening ratio was 3.0:1.0 by weight, and the emulsifiers lactylate hydrate and lecithin ratio was 3.0:1.0 by weight. The eggs were a preserved whole egg fluid material containing about 50 wt-% sugar, with a whole egg to sugar ratio of 1.0:1.0.

### EXAMPLE 1

A sugar cookie dough composition having 20.60% sucrose, 8.22% fluid corn syrup/sugar blend, 14.57% shortening, 36.47% flour, 13.61% preserved eggs, 3.21% emulsifier, 1.53% flavoring, 1.17% encapsulated sodium bicarbonate, 0.51% salt, and 0.10% mold inhibitor, all measured by weight, was made, and the ingredients combined according to the method outlined above. The A_{w} value for the final sweet goods dough product composition was 0.76, and the pH value was 8.17.

### EXAMPLE 2

A chocolate chip cookie dough composition having 18.34% sucrose, 7.32% fluid corn syrup/sugar blend, 12.97% shortening, 32.47% flour, 12.12% preserved eggs, 2.85% emulsifier, 1.36% flavoring, 1.04% encapsulated sodium bicarbonate, 0.46% salt, 0.09% mold inhibitor, and 10.98% chocolate chips, all measured by weight, was made, and the ingredients combined according to the method outlined above. The A_{w} value for the final sweet goods dough product composition was 0.757 and the pH value was 8.17.

### EXAMPLE 3

An oatmeal/raisin cookie dough composition having 15.44% sucrose, 6.16% fluid corn syrup/sugar blend, 10.90% shortening, 24.64% flour, 10.20% preserved eggs, 2.40% emulsifier, 1.10% flavoring, 1.16% baking powder, 0.78% encapsulated sodium bicarbonate, 0.38% salt, 0.08% mold inhibitor, 7.51% rolled oats, and 19.25% raisins, all measured by weight, was made, and the ingredients combined according to the method outlined above. Baking powder was mixed with the flour and the resulting mixture was added to and mixed with the first creamed slurry. The A_{w} value for the final sweet goods dough product composition was 0.719 and the pH value was 8.04.

### EXAMPLE 4

A double chocolate cookie dough composition having 17.31% sucrose, 6.90% fluid corn syrup/sugar blend, 12.05% shortening, 30.20% flour, 11.43% preserved eggs, 2.69% emulsifier, 1.28% flavoring, 0.97% encapsulated sodium bicarbonate, 0.43% salt, 0.086% mold inhibitor, 5.18% white chocolate chunks, 10.36% chocolate chunks, and 1.12% cocoa, all measured by weight, was made, and the ingredients were combined according to the method outlined above. The cocoa was added with the first group of ingredients to produce the first creamed slurry. The A_{w} value for the final sweet goods dough product composition was 0.754 and the pH value was 7.47.

In the early development of the sweet goods dough invention, five similar cookie dough compositions, sugar, chocolate chip, candy bits, double chocolate, and oatmeal/raisin were each analyzed for A_{w} and pH in triplicate. The A_{w} value determinations ranged from 0.711 to 0.768 and, depending on the particular variety, the A_{w} values averaged from 0.718 to 0.765. Similarly, the pH value determinations ranged from 6.53 to 7.39 and, depending on the particular variety, the pH averaged from 6.55 to 7.33.

In addition to the four above-described cookie dough compositions, a shelf stable brownie dough composition is also described.

### EXAMPLE 5

A chocolate brownie dough composition having 21.67% sucrose, 18.97% fluid corn syrup/sugar blend, 12.46% shortening, 26.01% flour, 10.84% preserved eggs, 1.56% emulsifier, 1.46% flavoring, 0.52% encapsulated sodium bicarbonate, 0.52% sodium aluminum phosphate, 0.26% salt, 0.52% mold inhibitor, and 5.20% cocoa, all measured by weight, was made. In this example, the fluid corn syrup/sugar blend to sucrose ratio was 1.0:1.5 by weight, the shortening was all liquid shortening, and the emulsifier was all lactylate hydrate. The eggs were a preserved whole egg fluid material containing about 50 wt-% sugar, with a whole egg to sugar ratio of 1.0:1.0. The ingredients were combined according to the method outlined below. The A_{w} value for the final sweet goods dough product composition was 0.73 and the pH value was 6.58.

Also included in the present invention is a process for preparing room temperature, ambient atmosphere, shelf stable brownie dough compositions. Since the process for preparing the brownie dough composition of the present invention involves sequential steps, the brownie dough is prepared by a batch process. A commercial mixing machine is employed to mix the ingredients in a single container. The process includes the steps of first mixing together all dry ingredients for four minutes. Next, the selected amount of wet ingredients is added to and mixed with the blended dry ingredients to produce a brownie dough mixture with a water activity less than about 0.75 and a pH with a range from about 6.5 to about 8.5.

Additional edible particulates, including chocolate chips, white and dark chocolate chunks, or various candy bits, are mixed into the brownie dough product to produce a brownie dough having the edible particulates distributed therein. Again, due to the stiff, viscous nature of the brownie dough, a VEMAG Robot 500, fitted with the 72 String Cheese 367 double screw auger, or a Marlen Model 629 or 670, is used for transferring and packing the brownie dough. The brownie dough product is transferred to a suitable container that can be sealed for storage of the brownie dough product at both room temperature and in an ambient atmosphere for at least about 90 days, and up to 210 days or more, without separation of components and without microbial growth. The containers for the brownie dough need not be oxygen impervious or air tight. Simple plastic containers with friction fit lids are sufficient, as discussed in detail above.

Federal regulations, known as the Licensed Acid Canned Food regulations (LACF), require a food product to have an A_{w} no more that 0.85 and a pH not to exceed 4.6 for designating the product as “shelf stable.” It was believed, prior to this invention, that an acidic pH of 4.6 or less was required to inhibit microbiological growth in a sweet dough. The inventors have confirmed through independent laboratory testing that the sweet goods dough compositions of the present invention are “shelf stable” at room temperature and in an ambient atmosphere for a period of at least about 120 days and up to about 210 days. Based upon the test results, it is believed that the sweet goods dough compositions of the present invention are exempt from the LACF regulations and can be designated as “shelf stable” sweet goods dough.

In each of the example compositions above, the A_{w} is less than about 0.75. Surprisingly, the pH for each of the example compositions is close to neutral or slightly basic. It had previously been believed that an acidic pH was required to inhibit microbiological growth. The pH of the example cookie dough compositions ranges from 7.47 to 8.17, while the example brownie dough has a pH of 6.58. Thus, the novel dough composition of the present invention is shelf stable with a low water activity, A_{w} less than about 0.75, and with a near neutral or basic pH with a range from about 6.5 to about 8.5.

In each of the above examples, the A_{w} value is no greater than about 0.75, which indicates that each of the resulting dough compositions is resistant to microbial degradation when stored at both room temperature and in an ambient atmosphere for a period of at least about 120 days. To confirm the stability of the dough composition to microbial and mycotic degradation, microbial and mycotic assays were performed on the dough composition of Example 2 above over a period of 120 days storage at room temperature and in an ambient atmosphere. Samples of dough were placed in clean, sealed containers held at room temperature and in an ambient atmosphere, with assays performed on a previously unopened sample at days 30, 60, 90 and 120. Samples were analyzed for the bacteria Bacillus cereus, Enterobacteriaceae, Clostridium perfringens, Coliforms, E. coli, Listeria, Psychrotrophs, Salmonella, Shigella, Staphylococcus, and Yersinia, as well as a Standard Plate Count (S.P.C.), an Anaerobic Plate Count (A.P.C.), a Yeast Count and a Mold Count. The assay results are presented in Table 1 below where colony forming units/gram (CFU/G) are the units of measure. No significant bacterial, yeast or mold growth was detected over the 120 day test period.

TABLE 1

| | All | | | | |
|---|---|---|---|---|---|
| | Bacteria | S. P. C. (Est.) | A. P. C. (Est.) | Yeast | Mold |
| Day 30 | Negative | 240 CFU/G | <10 CFU/G | <10 CFU/G | 90 CFU/G |
| Day 60 | Negative | 120 CFU/G | <10 CFU/G | <10 CFU/G | 25 CFU/G |
| Day 90 | Negative | 300 CFU/G | <10 CFU/G | <10 CFU/G | 190 CFU/G |
| Day 120 | Negative | 80 CFU/G | <10 CFU/G | <10 CFU/G | 15 CFU/G |

The sweet good dough of the present invention provides numerous advantages including, but not limited to, the following:

1) Shelf stability, including stability against microbiological growth and component separation at both room temperature and in an ambient atmosphere for at least about 90 days, and up to 210 days or more.

2) Refrigeration costs during transportation and storage of the sweet goods dough are eliminated.

3) Baking time is reduced versus refrigerated or frozen dough since the dough of the present invention is used at room temperature.

4) In the case of cookies made from the sweet goods dough, the baked product remains moist, pliable and palatable for up to two weeks after baking.

5) Manufacturing costs are minimized since no extra sterilization precautions are required and cooling equipment is not needed.

While the invention has been particularly shown and described with reference to preferred embodiments thereof, it will be understood by those skilled in the art that various changes in form and details may be made therein without departing from the spirit and scope of the invention.

We claim:

1. A sweet goods dough comprising;
(a) flour;
(b) sugar, including a fluid corn syrup/sugar blend;
(c) shortening;
(d) eggs;
(e) emulsifier;
(f) leavening; and
(g) mold inhibitor;
the sweet goods dough having an A_{w} of less than about 0.75, a pH with a range from about 6.5 to about 8.5, and stable against microbiological growth and component separation at both room temperature and in an ambient atmosphere.

2. The sweet goods dough of claim 1 wherein the flour is present in an amount to provide structure to the sweet goods dough.

3. The sweet goods dough of claim 1 wherein the flour comprises an amount in the range of about 20 to about 40 weight percent of the sweet goods dough.

4. The sweet goods dough of claim 1 wherein the flour includes bleached, enriched wheat flour.

5. The sweet goods dough of claim 1 wherein the flour includes barley flour.

6. The sweet goods dough of claim 1 wherein the flour includes bleached, enriched wheat flour and barley flour.

7. The sweet goods dough of claim 6 wherein the flour includes bleached, enriched wheat flour and barley flour in a weight ratio of about 10.0:1.0.

8. The sweet goods dough of claim 1 wherein the sugar, including a fluid corn syrup/sugar blend, is present in an amount to provide the sweet goods dough with an A_{w} of less than about 0.75.

9. The sweet goods dough of claim 1 wherein the sugar, including a fluid corn syrup/sugar blend, comprises an amount in the range of about 20 to about 40 weight percent of the sweet goods dough.

10. The sweet goods dough of claim 1 wherein the sugar includes sucrose.

11. The sweet goods dough of claim 10 wherein the sucrose includes white sugar.

12. The sweet goods dough of claim 10 wherein the sucrose includes brown sugar.

13. The sweet goods dough of claim 10 wherein the sucrose includes white sugar and brown sugar.

14. The sweet goods dough of claim 13 wherein the sucrose includes white sugar and brown sugar in a weight ratio of about 1.7:1.0.

15. The sweet goods dough of claim 1 wherein the sugar includes sucrose mixed with the eggs as a preservative thereof.

16. The sweet goods dough of claim 1 wherein the sugar includes a fluid blend of corn syrup, fructose, and liquid sucrose.

17. The sweet goods dough of claim 1 wherein the sugar includes a fluid blend of about 63% corn syrup, about 8% fructose, about 28% liquid sucrose, and about 1% imitation vanillin.

18. The sweet goods dough of claim 1 wherein the sugar includes sucrose and a fluid blend of corn syrup, fructose, and liquid sucrose.

19. The sweet goods dough of claim 18 wherein the sugar includes sucrose and a fluid blend of corn syrup, fructose, and liquid sucrose in a weight ratio of about 2.5:1.0.

20. The sweet goods dough of claim 1 wherein the sugar includes sucrose and sucrose mixed with the eggs as a preservative thereof.

21. The sweet goods dough of claim 1 wherein the sugar includes sucrose, a fluid blend of corn syrup, fructose, and liquid sucrose and sucrose mixed with the eggs as a preservative thereof.

22. The sweet goods dough of claim 1 wherein the shortening is present in an amount to enhance organoleptic properties of the sweet goods dough.

23. The sweet goods dough of claim 1 wherein the shortening comprises an amount in the range of about 10 to about 20 weight percent of the sweet goods dough.

24. The sweet goods dough of claim 1 wherein the shortening includes solid shortening.

25. The sweet goods dough of claim 24 wherein the solid shortening includes hydrogenated vegetable oil.

26. The sweet goods dough of claim 25 wherein the solid shortening includes hydrogenated soybean oil and cotton seed oil mixture.

27. The sweet goods dough of claim 1 wherein the shortening includes liquid shortening.

28. The sweet goods dough of claim 27 wherein the liquid shortening includes vegetable oil.

29. The sweet goods dough of claim 28 wherein the liquid shortening includes soybean oil.

30. The sweet goods dough of claim 1 wherein the shortening includes solid shortening and liquid shortening.

31. The sweet goods dough of claim 30 wherein the shortening includes solid shortening and liquid shortening in a weight ratio of about 3.0:1.0

32. The sweet goods dough of claim 30 wherein the solid shortening includes hydrogenated vegetable oil.

33. The sweet goods dough of claim 32 wherein the solid shortening includes hydrogenated soybean oil and cotton seed oil mixture.

34. The sweet goods dough of claim 30 wherein the liquid shortening includes vegetable oil.

35. The sweet goods dough of claim 34 wherein the liquid shortening includes soybean oil.

36. The sweet goods dough of claim 30 wherein the shortening includes hydrogenated vegetable oil and vegetable oil.

37. The sweet goods dough of claim 36 wherein the shortening includes hydrogenated vegetable oil and soybean oil.

38. The sweet goods dough of claim 37 wherein the shortening includes hydrogenated soybean oil and cotton seed oil mixture and soybean oil.

39. The sweet goods dough of claim 1 wherein the eggs are present in an amount to provide body to the sweet goods dough.

40. The sweet goods dough of claim 1 wherein the eggs include a preserved egg material comprising an amount in the range of about 8 to about 15 weight percent of the sweet goods dough.

41. The sweet goods dough of claim 1 wherein the eggs include a preserved egg material comprising whole eggs and sugar in a weight ratio of about 1.0:1.0.

42. The sweet goods dough of claim 1 wherein the emulsifier is present in an amount to prevent component separation of the sweet goods dough.

43. The sweet goods dough of claim 1 wherein the emulsifier comprises an amount in the range of about 2 to about 4 weight percent of the sweet goods dough.

44. The sweet goods dough of claim 1 wherein the emulsifier includes lactylate hydrate.

45. The sweet goods dough of claim 1 wherein the emulsifier includes lecithin.

46. The sweet goods dough of claim 1 wherein the emulsifier includes lactylate hydrate and lecithin.

47. The sweet goods dough of claim 46 wherein the emulsifier includes lactylate hydrate and lecithin in a weight ratio of about 3.0:1.0.

48. The sweet goods dough of claim 1 wherein the leavening is present in an amount to provide a predetermined density to a baked sweet goods dough.

49. The sweet goods dough of claim 1 wherein the leavening comprises an amount in the range of about 0.5 to about 1.5 weight percent of the sweet goods dough.

50. The sweet goods dough of claim 1 wherein the leavening includes sodium bicarbonate.

51. The sweet goods dough of claim 50 wherein the sodium bicarbonate is encapsulated.

52. The sweet goods dough of claim 1 wherein the mold inhibitor comprises an amount in the range of about 0.7 to about 10.2 weight percent of the sweet goods dough.

53. The sweet goods dough of claim 1 wherein the mold inhibitor includes a salt of sorbic acid.

54. The sweet goods dough of claim 53 wherein the salt of sorbic acid is potassium sorbate.

55. The sweet goods dough of claim 1 comprising;
(a) an amount of flour in the range of about 20 to about 40 weight percent;
(b) an amount of sugar, including a fluid corn syrup/sugar blend, in the range of about 20 to about 40 weight percent;
(c) an amount of shortening in the range of about 10 to about 20 weight percent;
(d) an amount of preserved eggs in the range of about 8 to about 15 weight percent;
(e) an amount of emulsifier in the range of about 2 to about 4 weight percent;
(f) an amount of leavening in the range of about 0.5 to about 1.5 weight percent; and
(g) an amount of mold inhibitor in the range of about 0.07 to about 0.12 weight percent.

56. The sweet goods dough of claim 1 comprising;
(a) an amount of flour in the range of about 30 to about 37 weight percent;
(b) an amount of sugar, including a fluid corn syrup/sugar blend, in the range of about 25 to about 36 weight percent;
(c) an amount of shortening in the range of about 10 to about 15 weight percent;
(d) an amount of preserved eggs in the range of about 10 to about 14 weight percent;
(e) an amount of emulsifier in the range of about 2 to about 4 weight percent;
(f) an amount of leavening in the range of about 0.9 to about 1.2 weight percent; and
(g) an amount of mold inhibitor in the range of about 0.08 to about 0.10 weight percent.

57. The sweet goods dough of claim 1, further comprising salt in an amount to improve taste of the sweet goods dough.

58. The sweet goods dough of claim 1, further including salt comprising an amount in the range of about 0.3 to about 0.6 weight percent of the sweet goods dough.

59. The sweet goods dough of claim 1, further comprising flavoring in an amount to improve taste of the sweet goods dough.

60. The sweet goods dough of claim 1, further including flavoring comprising an amount in the range of about 1.0 to about 1.7 weight percent of the sweet goods dough.

61. The sweet goods dough of claim 59 wherein the flavoring includes vanillin flavoring.

62. The sweet goods dough of claim 59 wherein the flavoring includes a butter, vanillin, and lemon flavoring.

63. The sweet goods dough of claim 59 wherein the flavoring includes vanillin flavoring and abutter, vanillin, and lemon flavoring.

64. The sweet goods dough of claim 63 wherein the flavoring includes vanillin flavoring and a butter, vanillin, and lemon flavoring in a weight ratio of about 2.0:1.0.

65. The sweet goods dough of claim 1, further comprising edible particulates.

66. The sweet goods dough of claim 65, wherein the edible particulates comprise an amount in the range of about 10 to about 30 weight percent of the sweet goods dough.

67. The sweet goods dough of claim 65 wherein the edible particulates include chocolate chips.

68. The sweet goods dough of claim 65 wherein the edible particulates include white chocolate chunks and dark chocolate chunks.

69. The sweet goods dough of claim 65 wherein the edible particulates include candy bits.

70. The sweet goods dough of claim 65 wherein the edible particulates include cocoa.

71. The sweet goods dough of claim 65 wherein the edible particulates include raisins.

72. The sweet goods dough of claim 65 wherein the edible particulates include oatmeal.

73. A sweet goods dough stable against microbiological growth and component separation at both room temperature and in an ambient atmosphere, comprising;
(a) a structure providing amount of flour;
(b) a source of sugar in an amount in the range of about 20 to about 40 weight percent, including a fluid corn syrup/sugar blend;
(c) an amount of shortening effective to enhance the organoleptic properties of the sweet goods dough;
(d) an amount of eggs to provide body to the sweet goods dough;
(e) an effective amount of emulsifier preventing component separation in the sweet goods dough;
(f) an effective amount of an encapsulated leavening system to provide a predetermined density to a baked sweet goods dough; and
(g) an effective amount of a mold inhibiting agent to prevent mold growth in the sweet goods dough, wherein the sweet goods dough has an A_{w} of less than about 0.75, and a pH with a range from about 6.5 to about 8.5.

74. The sweet goods dough of claim 73 wherein the flour comprises an amount in the range of about 20 to about 40 weight percent of the sweet goods dough.

75. The sweet goods dough of claim 73 wherein the flour includes bleached, enriched wheat flour and barley flour.

76. The sweet goods dough of claim 75 wherein the flour includes bleached, enriched wheat flour and barley flour in a weight ratio of about 10.0:1.0.

77. The sweet goods dough of claim 73 wherein the sugar includes sucrose.

78. The sweet goods dough of claim 77 wherein the sucrose includes white sugar and brown sugar.

79. The sweet goods dough of claim 78 wherein the sucrose includes white sugar and brown sugar in a weight ratio of about 1.7-1.0.

80. The sweet goods dough of claim 73 wherein the sugar includes sucrose mixed with the eggs as a preservative thereof.

81. The sweet goods dough of claim 73 wherein the sugar includes a fluid blend of corn syrup, fructose, and liquid sucrose.

82. The sweet goods dough of claim 73 wherein the sugar includes a fluid blend of about 63% corn syrup, about 8% fructose, about 28% liquid sucrose and about 1% imitation vanillin.

83. The sweet goods dough of claim 73 wherein the sugar includes sucrose and a fluid blend of corn syrup, fructose, and liquid sucrose.

84. The sweet goods dough of claim 83 wherein the sugar includes sucrose and a fluid blend of corn syrup, fructose, and liquid sucrose in a weight ratio of about 2.5:1.0.

85. The sweet goods dough of claim 73 wherein the sugar includes sucrose and sucrose mixed with the eggs as a preservative thereof.

86. The sweet goods dough of claim 73 wherein the sugar includes sucrose, a fluid blend of corn syrup, fructose, and liquid sucrose and sucrose mixed with the eggs as a preservative thereof.

87. The sweet goods dough of claim 73 wherein the shortening comprises an amount in the range of about 10 to about 20 weight percent of the sweet goods dough.

88. The sweet goods dough of claim 73 wherein the shortening includes solid shortening.

89. The sweet goods dough of claim 88 wherein the solid shortening includes hydrogenated soybean oil and cotton seed oil mixture.

90. The sweet goods dough of claim 73 wherein the shortening includes liquid shortening.

91. The sweet goods dough of claim 90 wherein the liquid shortening includes soybean oil.

92. The sweet goods dough of claim 73 wherein the shortening includes solid shortening and liquid shortening.

93. The sweet goods dough of claim 92 wherein the shortening includes solid shortening and liquid shortening in a weight ratio of about 3.0:1.0

94. The sweet goods dough of claim 92 wherein the solid shortening includes hydrogenated soybean oil and cotton seed oil mixture.

95. The sweet goods dough of claim 92 wherein the liquid shortening includes soybean oil.

96. The sweet goods dough of claim 92 wherein the shortening includes hydrogenated soybean oil and cotton seed oil mixture and soybean oil.

97. The sweet goods dough of claim 73 wherein the eggs include a preserved egg material comprising an amount in the range of about 8 to about 15 weight percent of the sweet goods dough.

98. The sweet goods dough of claim 73 wherein the eggs include a preserved egg material comprising whole eggs and sugar in a weight ratio of about 1.0:1.0.

99. The sweet goods dough of claim 73 wherein the emulsifier comprises an amount in the range of about 2 to about 4 weight percent of the sweet goods dough.

100. The sweet goods dough of claim 73 wherein the emulsifier includes lactylate hydrate.

101. The sweet goods dough of claim 73 wherein the emulsifier includes lecithin.

102. The sweet goods dough of claim 73 wherein the emulsifier includes lactylate hydrate and lecithin.

103. The sweet goods dough of claim 102 wherein the emulsifier includes lactylate hydrate and lecithin in a weight ratio of about 3.0:1.0.

104. The sweet goods dough of claim 73 wherein the leavening comprises an amount in the range of about 0.5 to about 1.5 weight percent of the sweet goods dough.

105. The sweet goods dough of claim 73 wherein the leavening includes sodium bicarbonate.

106. The sweet goods dough of claim 105 wherein the sodium bicarbonate is encapsulated.

107. The sweet goods dough of claim 73 wherein the mold inhibitor comprises an amount in the range of about 0.07 to about 0.12 weight percent of the sweet goods dough.

108. The sweet goods dough of claim 73 wherein the mold inhibitor includes a salt of sorbic acid.

109. The sweet goods dough of claim 108 wherein the salt of sorbic acid is potassium sorbate.

110. The sweet goods dough of claim 73 comprising;
(a) an amount of flour in the range of about 20 to about 40 weight percent;
(b) an amount of sugar, including a fluid corn syrup/sugar blend, in the range of about 20 to about 40 weight percent;
(c) an amount of shortening in the range of about 10 to about 20 weight percent;
(d) an amount of preserved eggs in the range of about 8 to about 15 weight percent;
(e) an amount of emulsifier in the range of about 2 to about 4 weight percent;
(f) an amount of leavening in the range of about 0.5 to about 1.5 weight percent; and
(g) an amount of mold inhibitor in the range of about 0.07 to about 0.12 weight percent.

111. The sweet goods dough of claim 73 comprising;
(a) an amount of flour in the range of about 30 to about 37 weight percent;
(b) an amount of sugar, including a fluid corn syrup/sugar blend, in the range of about 25 to about 36 weight percent;
(c) an amount of shortening in the range of about 10 to about 15 weight percent;
(d) an amount of preserved eggs in the range of about 10 to about 14 weight percent;
(e) an amount of emulsifier in the range of about 2 to about 4 weight percent;
(f) an amount of leavening in the range of about 0.9 to about 1.2 weight percent; and
(g) an amount of mold inhibitor in the range of about 0.08 to about 0.10 weight percent.

112. The sweet goods dough of claim 73, further including salt comprising an amount in the range of about 0.3 to about 0.6 weight percent of the sweet goods dough to improve taste thereof.

113. The sweet goods dough of claim 73, further including flavoring comprising an amount in the range of about 1.0 to about 1.7 weight percent of the sweet goods dough to improve taste thereof.

114. The sweet goods dough of claim 113 wherein the flavoring includes vanillin flavoring.

115. The sweet goods dough of claim 113 wherein the flavoring includes a butter, vanillin, and lemon flavoring.

116. The sweet goods dough of claim 113 wherein the flavoring includes vanillin flavoring and a butter, vanillin, and lemon flavoring.

117. The sweet goods dough of claim 116 wherein the flavoring includes vanillin flavoring and a butter, vanillin, lemon flavoring in a weight ratio of about 2.0:1.0.

118. The sweet goods dough of claim 73, further including edible particulates comprising an amount in the range of about 10 to about 30 weight percent of the sweet goods dough.

119. The sweet goods dough of claim 118 wherein the edible particulates includes chocolate chips.

120. The sweet goods dough of claim 118 wherein the edible particulates includes white chocolate chunks and dark chocolate chunks.

121. The sweet goods dough of claim 118 wherein the edible particulates includes candy bits.

122. The sweet goods dough of claim 118 wherein the edible particulates includes cocoa.

123. The sweet goods dough of claim 118 wherein the edible particulates includes raisins.

124. The sweet goods dough of claim 118 wherein the edible particulates includes oatmeal.

125. A sweet goods dough, shelf stable at both room temperature and in an ambient atmosphere, comprising;
(a) structure-providing flour in the range of about 30 to about 37 weight percent;
(b) sugar, including a fluid corn syrup/sugar blend, the sugar in the range of about 25 to about 36 weight percent;
(c) shortening in the range of about 10 to about 15 weight percent, effective to enhance the organoleptic properties of the sweet goods dough;
(d) preserved eggs in the range of about 10 to about 14 weight percent, providing body to the sweet goods dough;
(e) emulsifier in the range of about 2 to about 4 weight percent, preventing dough component separation;
(f) an encapsulated leavening system in the range of about 0.9 to about 10.2 weight percent, providing a predetermined density to a baked sweet goods dough; and
(g) a mold inhibiting agent in the range of about 0.08 to about 0.10 weight percent, preventing mold growth in the sweet goods dough,
the sweet goods dough having an A_{w} of less than about 0.75, a pH with a range from about 6.5 to about 8.5, and stable against microbiological growth and component separation at both room temperature and in an ambient atmosphere.

126. The sweet goods dough of claim 125, further including salt comprising an amount in the range of about 0.3 to about 0.6 weight percent of the sweet goods dough.

127. The sweet goods dough of claim 125, further including flavoring comprising an amount in the range of about 1.0 to about 1.7 weight percent of the sweet goods dough.

128. The sweet goods dough of claim 125, further including edible particulates comprising an amount in the range of about 10 to about 30 weight percent of the sweet goods dough.

129. A method for preparing a sweet goods dough comprising the steps of;
(a) mixing sugar, a fluid corn syrup/sugar blend, shortening, eggs, emulsifier, flavoring, salt and mold inhibitor to form a creamed slurry;
(b) mixing flour with the creamed slurry to produce a first dough mixture; and
(c) mixing leavening with the first dough mixture to produce a final sweet goods dough product with an A_{w} of less than about 0.75, a pH with a range from about 6.5 to about 8.5, the final sweet goods dough product being stable against microbiological growth and component separation at both room temperature and in an ambient atmosphere.

130. The method of claim 129, further comprising the step of;
mixing edible particulates with the final sweet goods dough product to form an edible particulates containing final sweet goods dough product.

131. The method of claim 130 wherein the edible particulates include chocolate chips.

132. The method of claim 130 wherein the edible particulates include dark chocolate chunks, white chocolate chunks and cocoa.

133. The method of claim 130 wherein sodium carbonate is included in mixing step (a) to form a creamed slurry, and the edible particulates include rolled oats and raisins.

134. The method of claim 129 wherein,
(a) flour comprises an amount in the range of about 20 to about 40 weight percent of the final sweet goods dough product;
(b) sugar, including a fluid corn syrup/sugar blend, comprises an amount in the range of about 20 to about 40 weight percent of the final sweet goods dough product;
(c) shortening comprises an amount in the range of about 10 to about 20 weight percent of the final sweet goods dough product;
(d) preserved eggs comprises an amount in the range of about 8 to about 15 weight percent of the final sweet goods dough product;
(e) emulsifier comprises an amount in the range of about 2 to about 4 weight percent of the final sweet goods dough product;
(f) leavening comprises an amount in the range of about 0.5 to about 1.5 weight percent of the final sweet goods dough product;
(g) flavoring comprises an amount in the range of about 1.0 to about 1.7 weight percent of the final sweet goods dough product;
(h) salt comprises an amount in the range of about 0.3 to about 0.6 weight percent of the final sweet goods dough product; and
(i) mold inhibitor comprises an amount in the range of about 0.07 to about 0.12 weight percent of the final sweet goods dough product.

135. The method of claim 130 wherein edible particulates comprise an amount in the range of about 10 to about 30 weight percent of the final sweet goods dough product.

136. The method of claim 129 wherein,
(a) flour comprises an amount in the range of about 30 to about 37 weight percent of the final sweet goods dough product;
(b) sugar, including a fluid corn syrup/sugar blend, comprises an amount in the range of about 25 to about 36 weight percent of the final sweet goods dough product;
(c) shortening comprises an amount in the range of about 10 to about 15 weight percent of the final sweet goods dough product;
(d) preserved eggs comprises an amount in the range of about 10 to about 14 weight percent of the final sweet goods dough product;
(e) emulsifier comprises an amount in the range of about 2 to about 4 weight percent of the final sweet goods dough product;
(f) leavening comprises an amount in the range of about 0.9 to about 1.2 weight percent of the final sweet goods dough product;
(g) flavoring comprises an amount in the range of about 1.0 to about 1.7 weight percent of the final sweet goods dough product;
(h) salt comprises an amount in the range of about 0.3 to about 0.6 weight percent of the final sweet goods dough product; and
(i) mold inhibitor comprises an amount in the range of about 0.08 to about 0.10 weight percent of the final sweet goods dough product.

137. A method for preparing a sweet goods dough that is stable against microbiological growth and component separation at both room temperature and in an ambient atmosphere, comprising the steps of;
(a) mixing together selected amounts of sugar, fluid corn syrup/sugar blend, shortening, eggs, emulsifier, flavoring, salt and mold inhibitor to form a creamed slurry;
(b) mixing a selected amount of flour with the creamed slurry to produce a first dough mixture; and
(c) mixing a selected amount of leavening with the first dough mixture to produce a final sweet goods dough product with an A_{w} of less than about 0.75, and a pH with a range from about 6.5 to about 8.5.

138. The method of claim 137, further comprising the step of;
mixing a selected amount of edible particulates with the final sweet goods dough product to form an edible particulate containing final sweet goods dough product.

139. The method of claim 138 wherein the edible particulates include chocolate chips.

140. The method of claim 138 wherein the edible particulates include dark chocolate chunks, white chocolate chunks and cocoa.

141. The method of claim 138 wherein sodium carbonate is included in mixing step (a) to form a creamed slurry, and the edible particulates include rolled oats and raisins.

142. The method of claim 137 wherein the selected amount of
(a) flour comprises an amount in the range of about 30 to about 37 weight percent of the final sweet goods dough product;
(b) sugar, including a fluid corn syrup/sugar blend, comprises an amount in the range of about 25 to about 36 weight percent of the final sweet goods dough product;
(c) shortening comprises an amount in the range of about 10 to about 15 weight percent of the final sweet goods dough product;
(d) preserved eggs comprises an amount in the range of about 10 to about 14 weight percent of the final sweet goods dough product;
(e) emulsifier comprises an amount in the range of about 2 to about 4 weight percent of the final sweet goods dough product;
(f) leavening comprises an amount in the range of about 0.9 to about 1.2 weight percent of the final sweet goods dough product;
(g) flavoring comprises an amount in the range of about 1.0 to about 1.7 weight percent of the final sweet goods dough product;
(h) salt comprises an amount in the range of about 0.3 to about 0.6 weight percent of the final sweet goods dough product; and
(i) mold inhibitor comprises an amount in the range of about 0.08 to about 0.10 weight percent of the final sweet goods dough product.

143. The method of claim 138 wherein the selected amount of edible particulates comprise about 10-30 weight percent of the edible particulate containing final sweet goods dough product.

144. A sweet goods dough comprising;
(a) an amount of flour in the range of about 30 to about 37 weight percent;
(b) an amount of sugar, including a fluid corn syrup/sugar blend, in the range of about 25 to about 36 weight percent;
(c) an amount of shortening in the range of about 10 to about 15 weight percent;
(d) an amount of preserved eggs in the range of about 10 to about 4 weight percent;
(e) an amount of emulsifier in the range of about 2 to about 4 weight percent;
(f) an amount of leavening in the range of about 0.9 to about 1.2 weight percent; and
(g) an amount of mold inhibitor in the range of about 0.08 to about 0.10 weight percent, the sweet goods dough stable against microbiological growth and component separation at both room temperature and in an ambient atmosphere for at least about 90 days.

145. The sweet goods dough according to claim 144 further including;
(h) salt comprising an amount in the range of about 0.3 to about 0.6 weight percent of the sweet goods dough;
(i) flavoring comprising an amount in the range of about 1.0 to about 1.7 weight percent of the sweet goods dough; and
(j) edible particulates comprising an amount in the range of about 10 to about 30 weight percent of the sweet goods dough.

146. A method for transferring and packaging of a sweet goods dough composition comprising the steps of;
(a) providing a filling machine with a dough reservoir and a dough transfer mechanism;
(b) filling the dough reservoir with a sweet goods dough composition comprising,
(i) flour comprising an amount in the range of about 30 to 37 weight percent of the final sweet goods dough product;
(ii) sugar, including a fluid corn syrup/sugar blend, comprising an amount in the range of about 25 to about 36 weight percent of the final sweet goods dough product;
(iii) shortening comprising an amount in the range of about 10 to about 15 weight percent of the final sweet goods dough product;
(iv) preserved eggs comprising an amount in the range of about 10 to about 14 weight percent of the final sweet goods dough product;
(v) emulsifier comprising an amount in the range of about 2 to about 4 weight percent of the final sweet goods dough product;
(vi) leavening comprising an amount in the range of about 0.9 to about 1.2 weight percent of the final sweet goods dough product;
(vii) flavoring comprising an amount in the range of about 1.0 to about 1.7 weight percent of the final sweet goods dough product;
(viii) salt comprising an amount in the range of about 0.3 to about 0.6 weight percent of the final sweet goods dough product;
(ix) mold inhibitor comprising an amount in the range of about 0.08 to about 0.10 weight percent of the final sweet goods dough product; and
(c) transferring the sweet goods dough composition from the dough reservoir via the dough transfer mechanism to a dough container.

147. The method of claim 146 wherein the filling machine dough transfer mechanism is a double screw auger.

148. The method of claim 146 wherein the filling machine dough transfer mechanism is twin pistons.
